(19) United States
(12) Patent Application Publication
(10) Pub. No.: US 2013/0122232 A1
(43) Pub. Date: May 16, 2013

(54) EXPANDABLE FLASHING MEMBRANE

(71) Applicant: PROTECTO WRAP COMPANY, Denver, CO (US)

(72) Inventor: John R. Hopkins, II, Bow Mar, CO (US)

(73) Assignee: PROTECTO WRAP COMPANY, Denver, CO (US)

(21) Appl. No.: 13/674,634

(22) Filed: Nov. 12, 2012

Related U.S. Application Data
(60) Provisional application No. 61/559,317, filed on Nov. 14, 2011.

(51) Int. Cl. E04B 1/66; B32B 37/10; E04D 13/14; B32B 3/06

(52) U.S. Cl. CPC E04B 1/665; B32B 3/06; B32B 37/10; E04D 13/14
USPC 428/40.3; 156/163; 428/41.8

(57) ABSTRACT

Disclosed herein are various membranes that may be applied to an opening in a building structure to seal around and/or waterproof the opening. To provide improved conformance of the membrane to underlying surfaces the membrane utilizes a facer film that permits permanent stretching without the application of little or any elastic/retractive forces by the facer film. In one embodiment, the length of the facer film is in excess of the length of an adhesive substrate of the membrane to allow stretching of the substrate without stretching the facer film. In another embodiment, the facer film has low elastic memory such that it plastically detail is as the underlying adhesive substrate stretches.

### CROSS-REFERENCE

The present application claims the benefit of the filing date of U.S. Provisional Application No. 61/559,317 entitled: “Expandable Flashing Membrane” and having a filing date of Nov. 14, 2011, the entire contents of which is incorporated herein by reference.

### FIELD

The presented inventions generally relate to building products and, more particularly, pertain to an impermeable flashing membrane that is adapted to waterproof surfaces and/or seal openings in building surfaces while permitting membrane expansion to accommodate improved conformance to irregularities of such surfaces.

### BACKGROUND

One failure point for unwanted air and/or moisture in a building envelope is around doors, windows and other openings/penetrations in the building structure (e.g., vent outlets, cable and utility ingress/egress). Controlling air and/or moisture infiltration through such openings is a serious concern as such moisture may result in exterior and interior damage if not prevented or corrected in a timely manner. In addition, energy losses (e.g., heat or air conditioning) caused by air leakage around openings and penetrations have taken on new significance due to today's high energy costs. Further, openings in a building structure also allow for the potential infiltration of, for example, rodents, insects and other unwanted organisms into the interior of such a building. Accordingly, there is a desire to effectively seal such openings to prevent moisture infiltration, energy losses and/or pest ingress.

Previously, caulking, expansive foams and/or using adhesive membranes have been utilized to seal gaps and thus minimize or close openings into a building. Caulking and expansive foams often fail to effectively seal such openings due to improper application and/or wear over time (e.g., cracking). Adhesive membranes, while providing a convenient method for sealing openings in a building structure (e.g., flashing around openings), suffer from various drawbacks. For instance, such membranes have a tendency to resist application about transverse and/or curved surfaces.

### SUMMARY

In view of the difficulties in applying an adhesive waterproofing membrane to transverse and/or surfaces, provided herein are systems and methods (i.e., utilities) associated with an adhesive waterproofing membrane that facilitates membrane conformance to permit membrane expansion or stretching during application.

A first aspect provides a flashing material for use in, for example, sealing about openings and/or apertures in a building structure. The flashing material includes an adhesive substrate layer having a top and bottom surface. Generally, such an adhesive substrate layer is a thin sheet-like material having a length that may be considerably in excess of its width. Often times, such material may have a width of between about 4 inches and about 12 inches and a length that may be many times greater. In this regard, the flashing material may be provided on a roll where a user may cut a desired length thereof. However, it will be appreciated that other lengths and widths are available and considered within the scope of the present invention. In various arrangements, the adhesive substrate layer is impervious to moisture. Further, a release sheet may be attached to the bottom surface of the adhesive substrate layer and may cover the entirety thereof. In this regard, the release sheet may be attached to the bottom surface and extend between a first end and a second end of the adhesive substrate layer. In this regard, the release sheet length may be equal to the substrate layer length. The flashing material also includes a facer film layer adhered to the top surface of the adhesive substrate layer. Again, the facer film layer may extend between the first and second ends of the adhesive substrate layer. However, an excess amount of facer film may be applied to this top surface. In this regard, prior to attachment of the facer film layer onto the top surface of the adhesive substrate layer, the length of the facer film may be between about 1.05 and about 1.5 times the length of the substrate between its first and second ends.

The over application of an excess length of facer film layer to the top surface of adhesive substrate layer results in bunching of the facer film as it is applied to the top layer. In this regard, a plurality of furrows or undulations are formed on the top surface of the flashing material between the first and second ends of the adhesive substrate layer. In one arrangement, these undulations or furrows include inside troughs and the adhesive substrate layer is disposed within at least a portion of these troughs. In any arrangement, the furrows in the facer material allow for stretching of the adhesive substrate layer without necessarily stretching the facer film layer.

The adhesive substrate layer may be formed of any material that provides the desired adhesive and impervious qualities. In one arrangement, the adhesive substrate layer comprises a bitumen material. In another arrangement, the adhesive substrate layer comprises a rubberized material (e.g., a butyl rubber compound). Other materials may be utilized.

In a further arrangement, in addition to excess application of facer film to the top surface of the substrate, the facer film itself may plastically deform in response to limited deformation. That is, the strain at yield of the facer material may be very low such that limited stretching of the underlying substrate may plastically deform the facer material. In this regard, the strain at yield of the facer material may be less than about 40%; less than about 25%; or even less than about 20%. In this regard, the facer film may deform when the adhesive substrate layer stretches and thus not provide an elastic resistance that may tend to retract the underlying adhesive layer away from the surface to which it adhered. However, while having a low strain at yield, it is desirable that the facer material have significant elongation at break. In one arrangement, the facer material has an elongation at break of at least 200%. In a further arrangement, the facer material has an elongation at break of at least 300%. In a yet further arrangement, the facer material is formed of a linear, low-density polyethylene film having some or all of the above-noted qualities.

The thickness of the facer film and adhesive substrate layer may be varied based on desired attributes. However, the facer film will typically be between about 0.5 mils and about 20 mils while the adhesive substrate layer will be between about 5 mils and about 100 mils.

In another aspect, a flashing material is provided. This flashing material includes an adhesive substrate layer having a top and bottom surface. A release sheet may be attached to the bottom surface for selective removal prior to application. The material further includes a facer material applied to the top surface of the adhesive substrate layer. This facer material is plastically deformable in response to low strain percentages such that it has little or no elastic memory.

In one arrangement of the subject aspect, the flashing material further includes a plurality of undulations in the top surface of the facer film. In one arrangement, these undulations are formed by the over application of the facer film to the top surface of the membrane. In such an arrangement, the length of the facer film prior to application to a length of substrate may have a length between 1.05 and 1.5 times the length of the substrate.

According to another aspect, a method is provided for forming a flashing material. The method includes providing a film layer at an inlet nip of a first lamination roller. Such a lamination roller is adapted to provide compressive pressure to the top surface of film layer. The first lamination roller may be rotated to laminate a bottom surface of the film layer onto a top surface of an adhesive substrate layer. To allow for the over application of the facer film onto the substrate layer, a circumferential speed of the first roller is greater than a movement speed of the underlying adhesive substrate layer as these materials are being laminated together. In this regard, the over speed/rotation of the roller in comparison to the movement of the substrate layer may result in a length of the facer film (prior to its application of this top surface of the substrate layer), having a length that is between 1.05 and about 1.5 times the length of the underlying substrate.

The over rotation of the lamination or compression roller that laminates the facer film onto the substrate may be utilized while the adhesive substrate layer moves on a conveyer. In another arrangement, both the adhesive substrate layer and the facer film are compressed together between a pair of lamination rollers. In such a further arrangement, a second lamination or compression roller may apply pressure to a bottom surface of the adhesive substrate layer. In this arrangement, the circumferential speed of the first lamination roller contacting the facer film may be greater than the circumferential speed of the compression roller contacting the adhesive substrate material.

According to another aspect, an apparatus is provided for generating an expandable flashing material. The apparatus includes a pair of lamination rollers that define an inlet nip. A first of the rollers is adapted to receive a face film material about a portion of its circumference. The first roller is thus operative to rotate and draw the facer material over its outside surface from a facer material supply. The second roller is adapted to receive an adhesive substrate material about a portion of is circumference, rotate, and draw the adhesive substrate material from an adhesive substrate material supply. The rollers are cooperatively positioned to compress a bottom surface of the facer material onto a top surface of the adhesive substrate material. Further, one or more controllers or adjustable drive systems (e.g., variable speed motors) allow for individual operation of the first and second rollers. Stated otherwise, the circumferential rotation speed of each roller may be individually set. In one non-limiting arrangement, the circumferential speed of the first roller may be set to be 1.05 to 1.5 times the circumferential speed of the second roller.

### BRIEF DESCRIPTION OF THE DRAWINGS

FIG. 1 is a perspective view of a first embodiment of an expansive membrane.

FIG. 2 is an exploded cross-sectional view of the membrane of FIG. 1.

FIG. 3 is a cross-sectional view of the membrane of FIG. 1.

FIGS. 4A-4C illustrate the application of a membrane to an underlying surface.

FIGS. 5A and 5B illustrate plastic defoiniation of a top surface facer film of the membrane.

FIG. 6 illustrates production of a membrane in accordance with one embodiment of the membrane.

FIGS. 7A and 7B illustrate use of expansive membranes to seal and opening around an element penetrating a wall surface of a structure.

### DETAILED DESCRIPTION

Reference will now be made to the accompanying drawings, which at least assist in illustrating the various pertinent features of the presented inventions. Furthermore, the description is not intended to limit the inventions to the forms disclosed herein. Consequently, variations and modifications commensurate with the following teachings, and skill and knowledge of the relevant art, are within the scope of the presented inventions. The embodiments described herein are further intended to explain the best modes known of practicing the inventions and to enable others skilled in the art to utilize the inventions in such, or other embodiments and with various modifications required by the particular application(s) or use(s) of the presented inventions.

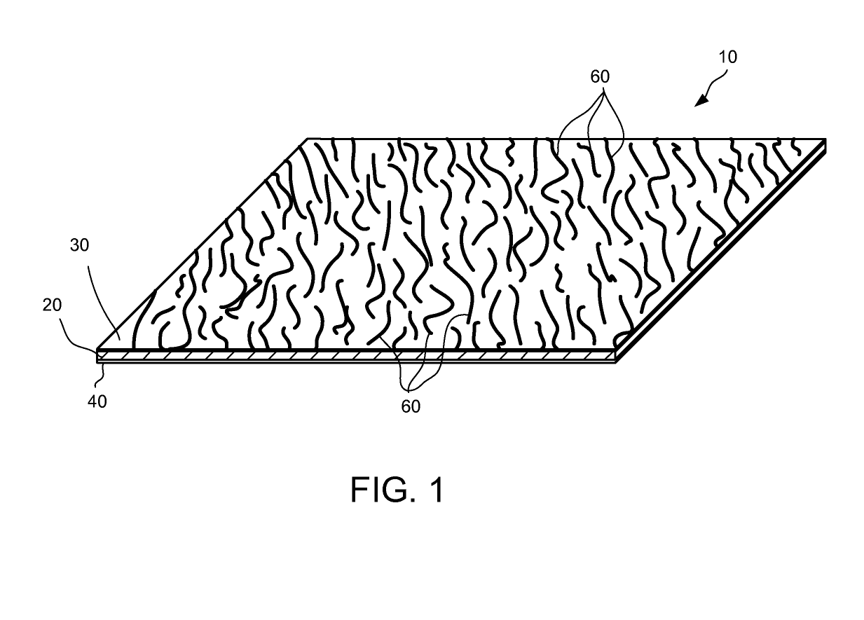

FIGS. 1-3 illustrate perspective, exploded cross-sectional and cross-sectional views, respectively, of one embodiment of an expandable membrane 10 that may be utilized for, among other uses, flashing openings in a building structure. Generally, the expandable membrane 10 is adapted for adhesive interconnection to a surface such that it may provide waterproofing qualities to the surface and/or seal openings through the surface. Stated otherwise, the membrane provides a substantially impermeable barrier that may be applied to a surface.

In the present embodiment, the membrane 10 is formed of an adhesive substrate layer 20 having a non-adhesive facer film 30 disposed on its top surface and a peel-away release sheet 40 disposed on its bottom surface. These material layers form a thin flexible sheet. For purposes of the discussion, the opposing surfaces of the adhesive substrate layer 20 are referred to as the top surface 22 and bottom surface 24, however, it will be appreciated that other naming conventions may be utilized. To enhance conformability of the resulting membrane 10, the thin facer material 30 is readily expandable to permit the stretching and adhesion of the underlying substrate 20 upon removal of the release sheet 40. Further, the facer material 30 provides a non-stick top surface for the membrane that allows a user to apply pressure to the membrane and thereby conform the bottom adhesive surface 24 to an application surface once the release sheet 40 has been removed. The facer film 30 may also provide, for example, wear protection and/or UV protection for the substrate layer 20.

The construction of the adhesive substrate layer 20 may be varied. For instance, the adhesive substrate layer 20 may be formed from any flexible sheet-like material that provides the desired level of impermeability. For instance, the substrate layer 20 may be formed from a sheet layer having an adhesive applied to one or both of the top and bottom surfaces 22, 24. In an alternate arrangement, the adhesive substrate layer 20 may be formed of a material that provides both waterproofing properties (e.g., impermeability) as well as adhesive properties. In one particular arrangement, the adhesive substrate layer 20 is formed from a bitumen-containing material. Such bitumen-containing materials may allow a bitumen-containing layer to provide adhesive qualities for the membrane 10 as well as provide waterproofing qualities for the membrane 10. Additionally, in various embodiments, the adhesive substrate layer 20 may itself be a multilayered structure. For instance, the adhesive substrate layer 20 may be constructed having one or more reinforcing layers (e.g., mesh layers), base sheet layers (e.g., plastic sheet layers) and/or various adhesive layers. However, in the present embodiment, the adhesive substrate layer 20 is formed of homogonous adhesive material layer (e.g., bitumen layer) that is free of internal reinforcement to provide improved elasticity for the resulting membrane. In various embodiments, the adhesive substrate layer has an elongation at break of at least 200% and more typically an elongation at break of over 300%. Stated otherwise, the adhesive substrate layer may stretch at least 2-3 times its original length without rupture.

Non-limiting examples of suitable materials for use in producing an adhesive substrate layer having waterproofing properties include bitumen-containing materials such as various tar adhesives and rubberized asphalts. Other material suitable for forming an adhesive substrate layer include, but is not limited to, acrylic, polyurethane, SEBS (styrene-ethylene/butylene-styrene), SBS (styrene butadiene styrene), APP modified bituminous, butyl, or butyl rubber compound, or other waterproofing compounds such as single component PVAc (polyvinyl acetate) water-resistant adhesive, water-resistant polyvinyl acetate adhesive, EVA (ethylene vinyl acetate)-hot melt adhesives, pressure sensitive hot melt adhesive atactic polypropylene (APP) base pressure sensitive tapes, polyurethane adhesives, thermoplastic adhesive film based on co-polyamides, thermoplastic adhesive film based with mixed polyolefin and co-polyamide, animal base adhesive, asphaltic base adhesive styrol or verstat acrylate types, and neoprene rubber cementic base adhesive, or other similar adhesive/compound known to those skilled in the art. The adhesive substrate layer can also be UV-resistant and/or have UV resistance enhancing additives.

The use of the adhesive substrate layer 20 allows for conveniently interconnecting the facer material 30 to its top surface 22. In this regard, the facer material 30 may be formed in a sheet and may be applied to an exposed adhesive surface of the substrate layer 20 in order to adhere the facer material 30 thereto. Such application may be performed utilizing compressive rollers in a manner similar to that disclosed in U.S. Pat. No. 6,676,779 entitled “Air and moisture barrier laminate apparatus” the entire contents of which are incorporated herein by reference.

As noted, the bottom surface 24 of the adhesive substrate layer 20 is adapted for adhesive interconnection to an application surface. To prevent premature adhesion of this bottom surface 24, the membrane 10 initially incorporates the release sheet 40 that is removably interconnected to the bottom surface 24 of the adhesive substrate layer 20. The release sheet 40 may be removed from the bottom surface 24 such that adhesive associated with the bottom surface 24 may be contacted with a surface for which membrane adhesion is desired. Many different foils, films, papers or other sheet materials are suitable for use in constructing the release sheet 40. For example, the release sheet 40 may be fanned from metals, plastics, or papers treated with silicon or other substances to provide a low level of adhesion to the underlying adhesive associated with the adhesive substrate layer 20. In any case, it is desirable that the release sheet 40 be easily removable from the adhesive substrate layer 20.

Aspects of the presented inventions are based upon the realization that in many instances membranes are utilized to provide water proofing and/or gap sealing of surface openings and in many such applications it may be desirable to stretch the membrane 10. One difficulty with stretching previous membranes has been the elasticity of a facer film applied to an underlying adhesive substrate. In this regard, when attempting to stretch the membrane to conform to a surface, the facer film has provided a resistive tension to the underlying adhesive substrate. This resistive tension (e.g., elasticity) attempts to return the facer film to its original shape/length upon deformation. More importantly this resistive tension/elasticity provides a retractive force that may pull the underlying adhesive substrate layer away from a surface to which the substrate layer is stretched to contact. In accordance with various aspects of the presented inventions, the presented membrane 10 counters the retractive/elastic characteristics of previous membranes in two different ways, which may be utilized alone and/or in combination. Stated otherwise, membranes are provided that allow for expansion or stretching of the adhesive substrate layer with little or no retractive force applied by a non-adhesive facer film. In a first arrangement, the membrane incorporates a facer film 30 having a length that is in excess of the corresponding length of an underlying adhesive substrate layer. In a second arrangement, the membrane utilizes a facer film that is multi-extensionable in that it has very low strain to yield strength (i.e. low shape memory) and thus readily plastically deforms with stretching of the underlying substrate layer.

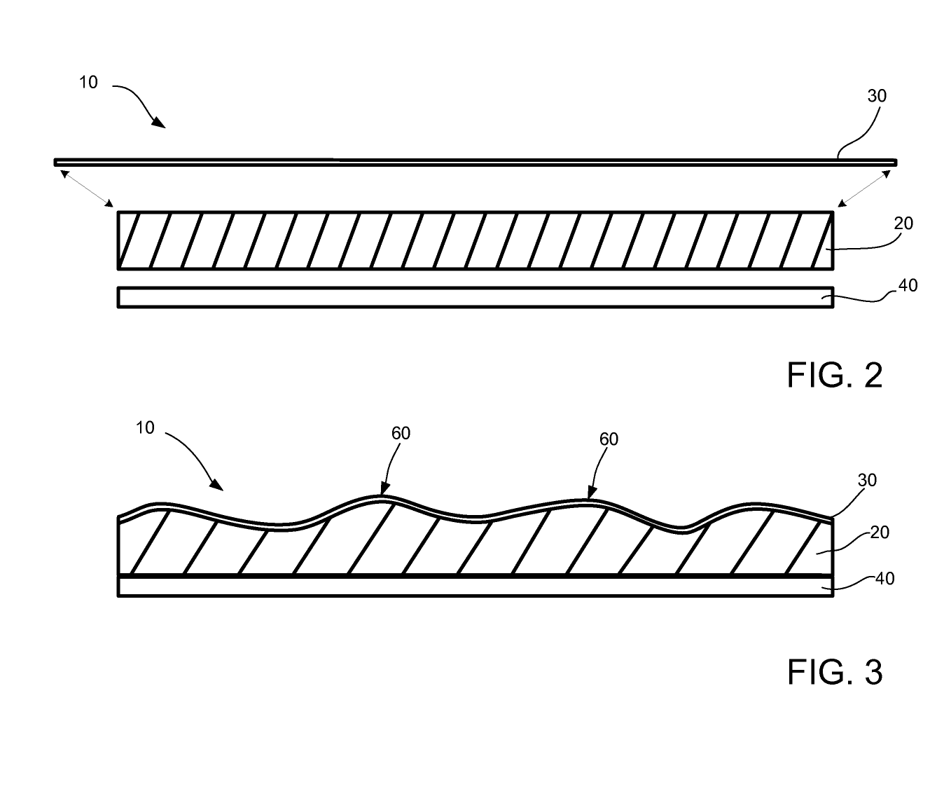

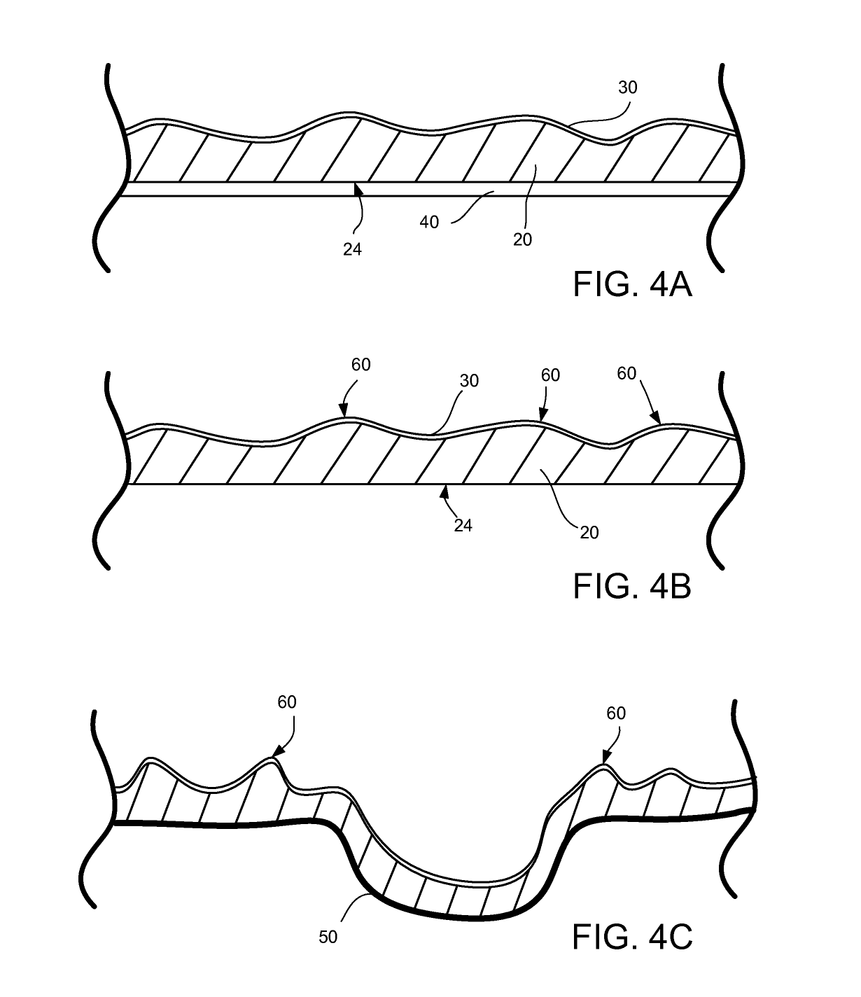

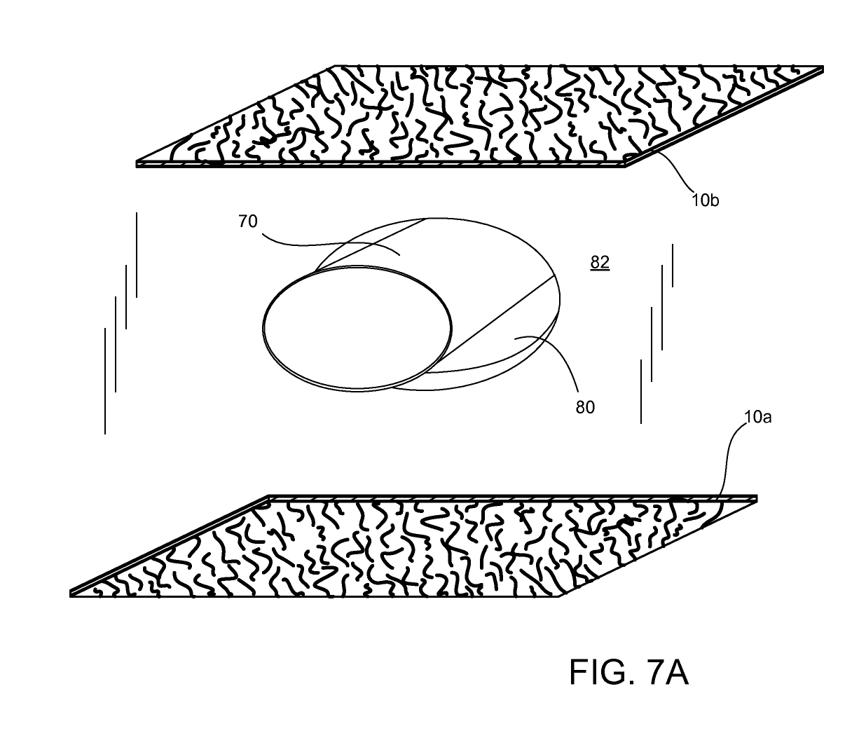

In the first arrangement, application of additional facer film 30 per unit length of substrate layer 20 results in a membrane 10 that has buckling or furrows 60 in its top surface that permit the underlying substrate layer 20 to easily stretch. As shown in FIGS. 2 and 3, the membrane 10 of the present embodiment includes a facer film 30 adhered to the top surface 22 of the substrate layer 20 that has a length that is in excess of the length of the substrate layer 20. As shown in FIG. 2, the substrate layer 20 and underlying release sheet 40 may have a common length between first and second ends thereof. In contrast, the facer film 30 may have a length that is between about 1.05 times and about 1.5 times the length of the underlying substrate/release sheet. Application of such an over-length facer film 30 to the top surface 22 of the substrate layer results in a buckling or furrowing of the top surface as illustrated in FIGS. 1 and 3. These buckles or furrows 60 form irregular undulations in the upper surface of the membrane 10. These furrows 60 allow expansion/stretching of the underlying substrate layer 20 without requiring stretching of the facer film 30. That is, stretching of the substrate layer 20 up to a point simply extends and flattens the furrows 60. The process for applying the over-length facer film 30 onto the adhesive substrate layer 20 is discussed in relation to FIG. 6. herein.

It will be appreciated that once the over-length facer film 30 is applied to the underlying length of the adhesive substrate layer 20, that the underlying substrate layer, which is readily stretchable in most instances and due to its adherence to an underlying application surface naturally overcomes any of its own internal retractive/elastic forces, may be stretched to fit a surface where the furrows 60 of the facer film 30 may extend or flatten to permit such expansion without stretching the facer film 30. Further, as such extension of these furrows 60 does not result in the stretching of the facer film 30, no retractive/elastic force is applied to the underlying adhesive substrate 20 when it is applied to an underlying surface.

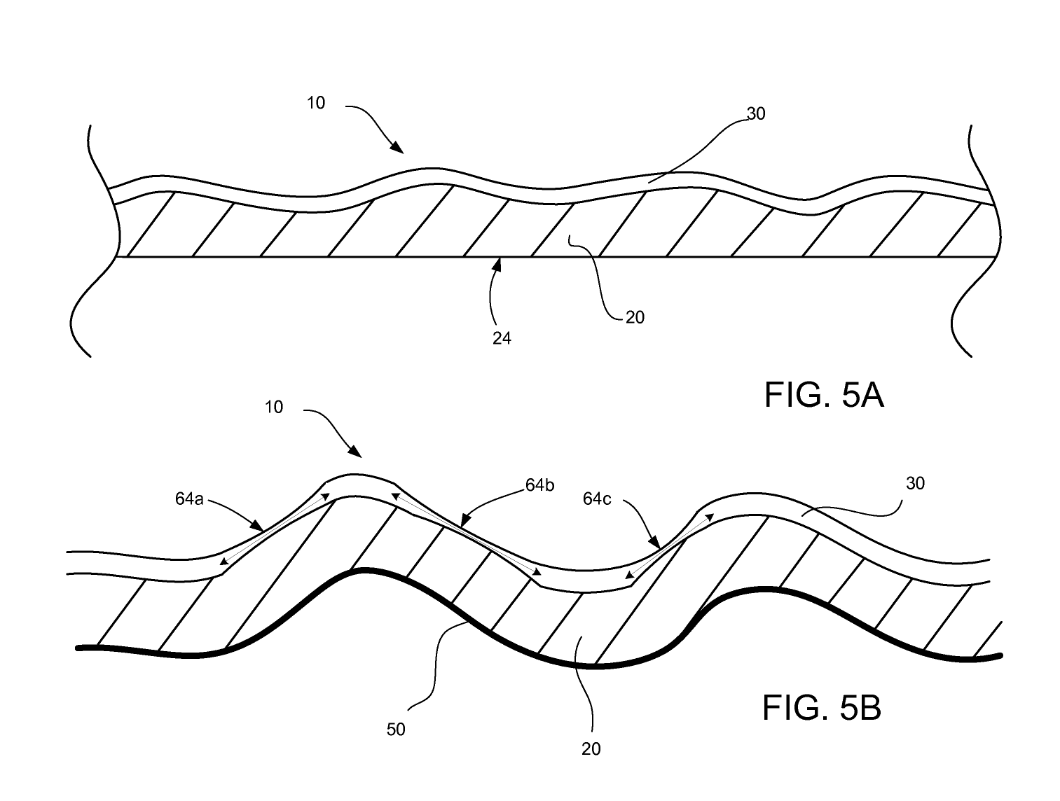

FIGS. 4A-4C illustrate the application of a membrane 10 having an over-length facer film 30 onto a concave underlying surface 50. Initially, the membrane 10 may be provided including the release sheet 40 on its lower surface 24. See FIG. 4A. Upon removing the release sheet, the bottom adhesive surface 24 may be exposed for application to an underlying surface 50. See FIG. 4B. In the present instance, the underlying surface 50 may be a curved or concave surface. Accordingly, when the membrane 10 is applied to the surface, it may require the stretching of the adhesive substrate 20 to fit to that surface. As shown in FIG. 4C, the stretching of the underlying substrate results in the flattening of the various furrows 60 in the facer film 30. In this regard, the extra length of the facer film 30 allows expanding the substrate 20 without necessarily stretching the facer film. Excessive length of the facer film 30 thereby allows for the expansion or stretching of the membrane 10 to fit irregularities in an underlying surface without applying retractive forces to the adhesive substrate 20 that could pull the substrate away from the underlying surface.

In another arrangement, the membrane 10 utilizes a low memory facer film that plastically deforms under minimal stress such that, when the membrane 10 is stretched to accommodate underlying structure, the facer film permanently deforms with the underlying substrate and thus provides little or no retractive/elastic force to the substrate. In this regard, the facer film may be considered a multi-extensionable film that contains low film memory. As will be appreciated, film memory is the ability of a stretched film to return to its original unstretched form (e.g., elastic memory). For the present application, it has been determined that suitable low-memory films have strain at yield value of less than about 25%. Such a low strain at yield provides the ability to readily and permanently deform upon application of the minimal stretching. That is, a strain at yield (a.k.a. elastic limit) where the facer material permanently deforms (i.e., plastically deforms) at an elongation of 25% or less. In a further arrangement a strain of yield of less than 20% has been determined to be desirable. In any arrangement, in addition to having a low strain at yield, it is also desirable that the facer film 30 have sufficient elongation-at-break to permit significant deformation of the underlying substrate. In this regard, it has been determined that having a elongation at break of at least about 200% and more preferably of at least about 300% is desirable. In this regard, such material may stretch 2 to 3 times its original length prior to rupture. Furthermore, with low strain at yield of less than 25% the majority of such stretching in the facer film would result in plastic deformation. In this regard, no or little elastic memory will be applied by the facer film 30 to the underlying substrate after the facer film has yielded.

Various different facer films corresponding with the above-noted limitations may be utilized. However, in one particular arrangement, it has been determined that low density polyethylene films are suitable for such application. Further, it has been determined that linear low density polyethylene provides yet further improved yield and elongation-at-break properties. This is due, in part, to the structure of low density polyethylene, which differs structurally from conventional low density polyethylene due to the absence of long chain branching in the polymer chain olfins.

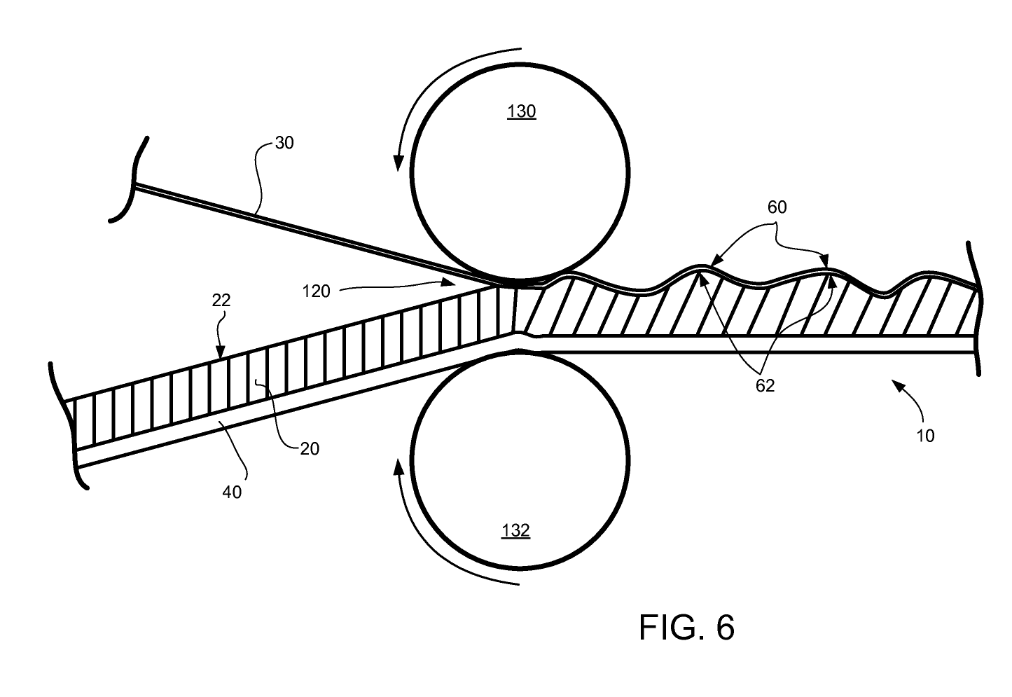

As illustrated in FIGS. 5A and 5B, use of a linear low density polyethylene film or other film that has desired yield and elongation-at-break properties allows for conforming a membrane 10 to an underlying surface 50 where the facer film 30 may be plastically deformed such that it applies no retractive/elastic forces onto the underlying substrate 20. Particularly, as shown in FIG. 5b, various portions 64a-c of the facer film 30 are shown to have plastically deformed where the thickness of the film has necked down (i.e. plastically deformed) to accommodate the stretch applied to the facer film 30 due to fitting the substrate 20 to the irregularities of the underlying surface 50.

It will be appreciated that the various components of the membrane 10 may be altered depending upon the desired application. However, for many applications the face film will have a thickness of less than about 10 mils with an adhesive substrate layer having a thickness of between about 5 mils and about 100 mils. Other thicknesses are possible and considered within the scope of the present invention.

As noted above, one or both arrangements of the expandable membrane require the application of an additional length of facer film to an underlying length of an adhesive substrate layer. Such additional or ‘over-application’ of the facer film 30 is illustrated in relation to FIG. 6 which illustrates a portion of a lamination machine that may be utilized to over apply facer film to an underlying substrate. Specifically, FIG. 6 illustrates the lamination of the facer material 30 to an exposed adhesive surface of the adhesive substrate layer 20. As shown, a supply of the facer material 30 (i.e., a sheet/strip) and a separate supply of the adhesive substrate layer 20 (i.e., as predisposed on a release sheet 40) are supplied to an inlet nip 120 of a pair of marriage or lamination rollers 130, 132. In the present embodiment, each of the rollers 130 and 132 is a drive roller that is operatively interconnected to a power source (e.g., electric motor) such that the rate of rotation of each roller 130, 132 may be individually controlled. As will be appreciated, each of the rollers is operative to rotate about its center axis and an axle extending through such a center axis may be attached to a frame of a laminating apparatus (not shown). Further, it will be appreciated that these rollers 130, 132 may be adjustable such that the distance between their surfaces may be increased or decreased in order to apply more or less compressive force there between and/or accommodate materials of differing thickness. Various other rollers, guide tracks and/or spindles are utilized to orient the combined adhesive substrate layer 20/release sheet 40 and the facer material 30 at the inlet nip 120 of the lamination rollers 130, 132. Supply rolls of the facer material 30 and the combined adhesive substrate layer 20/release sheet 40 may be provided on tensioned support spindles (not shown). Such an arrangement allows the materials to be drawn into the apparatus when the drive rollers 130 or 132 are controllably rotated. In a further arrangement, the adhesive substrate layer 20 may be laminated onto the release sheet 40 at a location prior to the combination with the facer material. That is, a single apparatus may permit the lamination of the adhesive substrate 20 to the release sheet 40 and the subsequent lamination of the combined adhesive substrate layer 20/release sheet 40 and the facer material 30.

It will be appreciated that the surfaces of the rollers 130, 132 may include any appropriate coating. For instance, the surface of one or both rollers 130, 132 may be tackified (e.g., rubberized) and/or textured in order to allow the rollers to grip the facer material 30 and/or adhesive substrate layer 20/release sheer 40 in order to draw these materials between the rollers. Additionally or alternatively, the rollers 130, 132 may contain a suitable nonstick coating and/or spray-on release agents to lessen or prevent adherence of materials to the rollers 130, 132.

As noted, the lamination rollers 130, 132 define a compressive inlet nip 120 there between. When the rollers 130, 132 are rotating as indicated by the arrows in FIG. 6, they are operative to receive the facer material 30 and adhesive substrate layer 20/release sheet 40 and draw or pull these materials between the rollers and thereby compress these materials together. As shown, the top adhesive surface 22 of the adhesive substrate layer 20 is exposed prior to entry into the inlet nip 120 of the lamination rollers 130, 132. Upon passing through the compressive rollers 130, 132 the facer material 30 is compressed against the adhesive top surface 22 of the adhesive substrate layer 20. Accordingly, the facer material 30 is adhered/laminated to the adhesive substrate layer 20 across its width.

In the present arrangement, the controlled rotation of both of the lamination rollers 130 and 132 is operative to draw the facer material 30 and adhesive substrate layer 20/release sheet 40 through the inlet nip at different speeds. Specifically, the lamination roller 130 that engages the facer material 30 may be rotated faster than the rotation of the lamination roller 132, which engages the combined adhesive substrate layer 20/release sheet 40. This over-rotation of this facer lamination roller 130 results in the buckling/furrowing of the facer material on the exposed top surface of the adhesive substrate layer 20. That is, the over-rotation of the roller 130 results in the length of facer material applied to the top surface of the adhesive substrate layer exceeding the length of the release sheet applied to the generally planar bottom surface of adhesive substrate layer 20. The excess length of the facer material 30 results in the furrows 60 on the top surface of the substrate layer 20 and, hence, the top surface of the resulting membrane 10.

Importantly, as these furrows are created during a compression process, the adhesive substrate 20 is forced/disposed within the inside troughs 62 of the furrows 60. Thus, even when the membrane is stretched and the furrows are flattened, there are few if any thin spots in the substrate layer as applied to an underlying surface.

It will be appreciated that the excess length of facer material 30 in relation to the underlying length of the substrate layer 20/release sheet 40 is a function of the over-rotation of the facer lamination roller 130. It has been determined that when adhering a 1 mil facer on an adhesive substrate layer, over-rotation of the facer lamination roller 130 in an amount of 125% of the rotation of the substrate lamination roller 132 results in adhering facer material having a length of between about 1.05 and 1.25 times the length of the underlying substrate layer 20/release sheet 40. Generally, it is believed that over-rotation of between 1.05 and 1.50 times will be sufficient for most membrane applications. However, it will be appreciated that other over-rotation speeds are possible and considered within the scope of the presented inventions. Further such speeds may be selected based in part on the materials being laminated and/or the thickness of those materials.

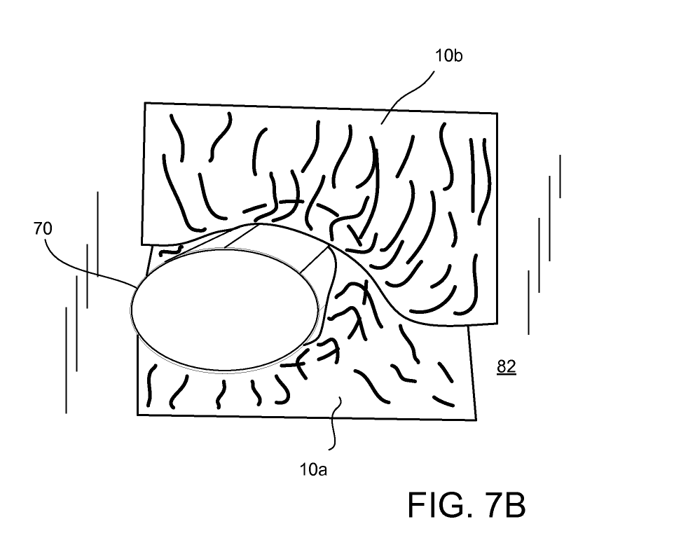

FIGS. 7A and 7B illustrate one application of the expandable membrane 10 as utilized in a flashing application. In such an application, one or more membranes 10a, 10b may be utilized to seal an opening in a structure. In the present embodiment, first and second membranes 10a, 10b are utilized to seal around a pipe 70 that extends through a hole/aperture 80 in a wall 82 of a building structure. As shown, the first membrane 10a may be applied around the bottom portion of the pipe 70 as well as to the surface of the wall 82. The expandable membrane may then be deformed to better conform to the transverse interface between the generally horizontal surface of the pipe 70 and the generally vertical outside surface of the wall 82. Likewise, the second membrane 10b may be applied around the outside surface of the top half of the pipe 70 and the wall 82 to further cover and close the hole through the wall. Again, the expandability of the membrane due to the furrows and/or plastically deformable facer films allows for conforming the membrane to these transfer surfaces while reducing or eliminating the tendency of the facer film to pull the membrane away from the surfaces.

While the invention has been described with reference to one embodiment, those skilled in the art will appreciate that certain substitutions, alterations and omissions may be made without departing from the spirit thereof. Accordingly, the foregoing description is meant to be exemplary only and should not be deemed limitative on the scope of the invention set forth with the following claims.

1. A flashing material, comprising:
an adhesive substrate layer having a top surface and a bottom surface and a substrate length between a first end and a second end, wherein the adhesive substrate layer is substantially impervious to moisture;
a release sheet attached to the bottom surface of the adhesive substrate layer and extending between the first and second ends, wherein a release sheet length is equal to the substrate length, and wherein the release sheet is removable from the bottom surface; and
a facer film layer adhered to the top surface of the adhesive substrate layer and extending between the first and second ends, wherein a length of the facer film prior to application to the top surface between the first and second ends of the adhesive substrate layer is between 1.05 and 1.5 times the substrate length.

2. The flashing material of claim 1, wherein the facer film defines a plurality of furrows between the first end and the second ends of the adhesive substrate layer.

3. The flashing material of claim 2, wherein the adhesive substrate layer is disposed within at least a portion of a trough of the furrows.

4. The flashing material of claim 1, wherein the facer film comprises a material having a strain at yield of less than 25% and an elongation at break of at least 300%.

5. The flashing material of claim 1, wherein the facer film comprises a linear low density polyethylene film.

6. The flashing material of claim 1, wherein the facer film has a thickness between about 0.5 mils and about 20 mils.

7. The flashing material of claim 1, wherein the flashing material has a thickness between about 5 mils and about 100 mils.

8. The flashing material of claim 1, wherein the adhesive substrate layer comprises a bituminous material.

9. The flashing material of claim 1, wherein the facer film is laminated to the top surface in using a pair of lamination rollers, wherein the a first of the pair of lamination rollers that applies pressure to the facer film rotates at a higher rate than the second of the pair of lamination rollers.

10. A flashing material comprising:
an adhesive substrate layer having a top surface and a bottom surface, wherein the adhesive substrate layer is substantially impervious to moisture;
a release sheet attached to the bottom surface of the adhesive substrate layer, wherein the release sheet is removable from the bottom surface; and
a facer film adhered to the top surface of the adhesive substrate layer, wherein the facer film comprises a plurality of undulations that permit initial stretching of the adhesive substrate substantially free of applying stain to the facer film.

11. The flashing material of claim 10, wherein a length of the facer film in a first direction is between 1.05 times and 1.5 times a corresponding length of the release sheet.

12. The flashing material of claim 10, wherein the facer film comprises a material having a strain at yield of less than 25% and an elongation at break of at least 300%.

13. The flashing material of claim 10, wherein the facer film comprises a linear low density polyethylene film.

14. The flashing material of claim 1, wherein the adhesive substrate layer comprises a bituminous material.

15. The flashing material of claim 1, wherein the furrows are irregularly distributed on the top surface.

16. A method of forming a flashing material comprising:
providing a film layer at an inlet nip of a first lamination roller, wherein a first roller applies compressive pressure to a top surface of the film layer;
rotating the first lamination roller to laminate a bottom surface of the film layer to a top surface of an adhesive substrate layer, wherein a circumferential speed of the first roller is greater than a movement speed of the adhesive substrate layer; and
wherein a length of the facer film prior to lamination to a substrate length of the substrate layer is between 1.05 and 1.5 times the substrate length.

17. The method of claim 16, wherein a circumferential speed is between 1.05 and 1.5 times the movement speed of the adhesive substrate layer.

18. The method of claim 16, further comprising:
providing the adhesive substrate layer at the inlet nip of the first lamination roller, wherein a second lamination roller applies a compressive pressure to a bottom surface of the adhesive substrate layer;

19. The method of claim 18, further comprising:
operating the first roller at a circumferential speed that is greater than a circumferential speed of the second roller.

20. The method of claim 19, wherein the circumferential speed of the first roller is between 1.05 and 1.5 times the circumferential speed of the second roller.
